(19) United States
(12) Patent Application Publication
(10) Pub. No.: US 2004/0128700 A1
(43) Pub. Date: Jul. 1, 2004

(54) Viewing selection management system

(76) Inventor: Ming-Da Pan, Beijing (CN)

Correspondence Address: LEE & HAYES PLLC, 421 W RIVERSIDE AVENUE SUITE 500, SPOKANE, WA, 99201

(21) Appl. No.: 10/331,822

(22) Filed: Dec. 30, 2002

(51) Int. Cl. H04N 7/16

(52) U.S. Cl. 725/136; 725/141

(57) ABSTRACT

In an implementation of a viewing selection management system, a first viewing selection is displayed as a primary display, such as on a display device. A task input corresponding to a new or pending task is received where the task input is an accept task input, a pause task input, a deny task input, or no input. If an accept task input is received, the new or pending task is displayed as a second viewing selection within the primary display, such as picture-in-picture display. If a deny task input is received, the new or pending task is deleted, and if a pause task input or no task input is received, a new task is stored on a stack memory and a pending task continues to be maintained with the stack memory.

### TECHNICAL FIELD

This invention relates to viewing television-based tasks and, in particular, to a viewing selection management system.

### BACKGROUND

In an interactive television system, it is difficult for a viewer to navigate multiple television viewing and/or information applications due to the limitations of conventional television interfaces. For example, a viewer can have a television program displayed for viewing and then have to switch to a messenger application display to communicate via video-conferencing. Depending on the interactive television system, switching between the many associated tasks and/or applications can be confusing with each typically providing a different user interface and requiring different user inputs to control and manage the tasks and applications.

Accordingly, for television-based entertainment and information systems, there is a need for an intuitive and user-friendly interface to manage the many associated program viewing and information applications.

### SUMMARY

A viewing selection management system is described herein.

In an implementation, a first viewing selection is displayed as a primary display, such as on a display device. A task input corresponding to a new or pending task is received where the task input is an accept task input, a pause task input, a deny task input, or no input. If an accept task input is received, the new or pending task is displayed as a second viewing selection within the primary display, such as a picture-in-picture display. If a deny task input is received, the new or pending task is deleted, and if a pause task input or no task input is received, a new task is stored on a stack memory and a pending task continues to be maintained with the stack memory.

### BRIEF DESCRIPTION OF THE DRAWINGS

The same numbers are used throughout the drawings to reference like features and components.

FIG. 1 illustrates various components of an exemplary system to implement a viewing selection management system.

FIG. 2 illustrates an exemplary state diagram of a viewing selection management system.

FIG. 3 is a flow diagram that illustrates an exemplary method for a viewing selection management system.

FIG. 4 is a flow diagram that illustrates an exemplary method for a viewing selection management system.

FIG. 5 is a flow diagram that illustrates an exemplary method for a viewing selection management system.

FIG. 6 illustrates various components of an exemplary client device implemented in a television-based entertainment and information system.

FIG. 7 illustrates an exemplary system architecture in which a viewing selection management system can be implemented.

### DETAILED DESCRIPTION

Television-based entertainment systems are increasingly utilized as multi-information systems by which a user can interface to view programs, watch movies, conduct business, shop via e-commerce, communicate via video-phone, browse the Web (e.g., World Wide Web), monitor local events and the weather, network with others, and any number of different tasks that may be of interest to a user of the system. A viewing selection management system can be implemented as an appliance device that provides the many features of television-based entertainment as well as provides a system to easily manage the many possible information and user-interactive tasks associated with the multi-information systems. The viewing selection management system described herein utilizes the picture-in-picture interface and an electronic program guide application to create an intuitive task management system.

The following discussion is directed to television-based entertainment and information systems, such as interactive television networks, cable networks, and Web-enabled television networks. Client devices in such systems range from full-resource clients with substantial memory and processing resources, such as television-enabled personal computers and television recorders equipped with hard-disks, to low-resource clients with limited memory and/or processing resources, such as traditional set-top boxes. While aspects of the described systems and methods can be used in any of these systems and for any types of client devices, they are described in the context of the following exemplary environment.

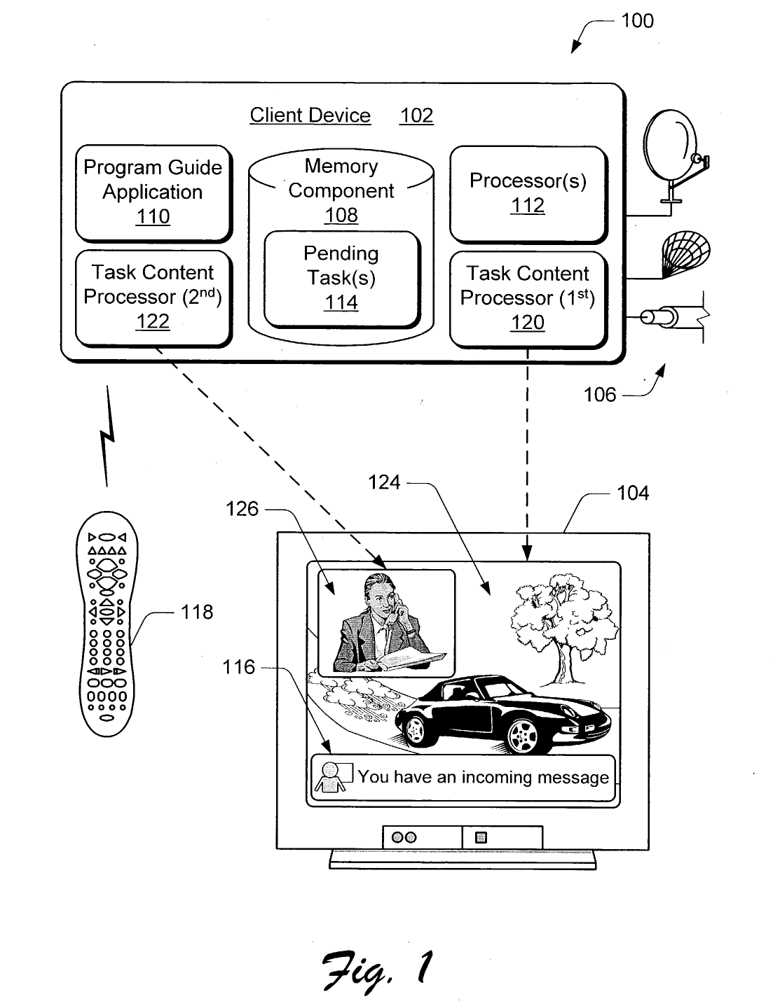

FIG. 1 illustrates various components of an exemplary viewing selection management system 100 which includes a client device 102 and a display device 104. Client device 102 receives broadcast content and task data via various transmission media 106, such as satellite transmission, radio frequency transmission, cable transmission, and/or via any number of other transmission media, such as via a broadband network or via the Internet. A task can include any operation performed by client device 102 that involves user interaction, such as selecting a program channel to render a particular program, requesting a video on-demand movie, responding to a video-phone call, browsing program channels, movie listings, the Web (e.g., World Wide Web), and the like, interfacing with a software application, networking, on-line gaming, e-commerce applications, and any number and different types of tasks that a user can manage via client device 102.

Client device 102 can receive the broadcast content, task data, and/or video on-demand programs from a headend in a television-based content distribution system, for example, that provides the content and data, as well as program guide data, to multiple client devices. Client device 102 can be implemented in any number of embodiments, such as a set-top box, a digital video recorder (DVR) and playback system, a personal video recorder (PVR) and playback system, an appliance device, and as any other type of client device that may be implemented in a television-based entertainment and information system.

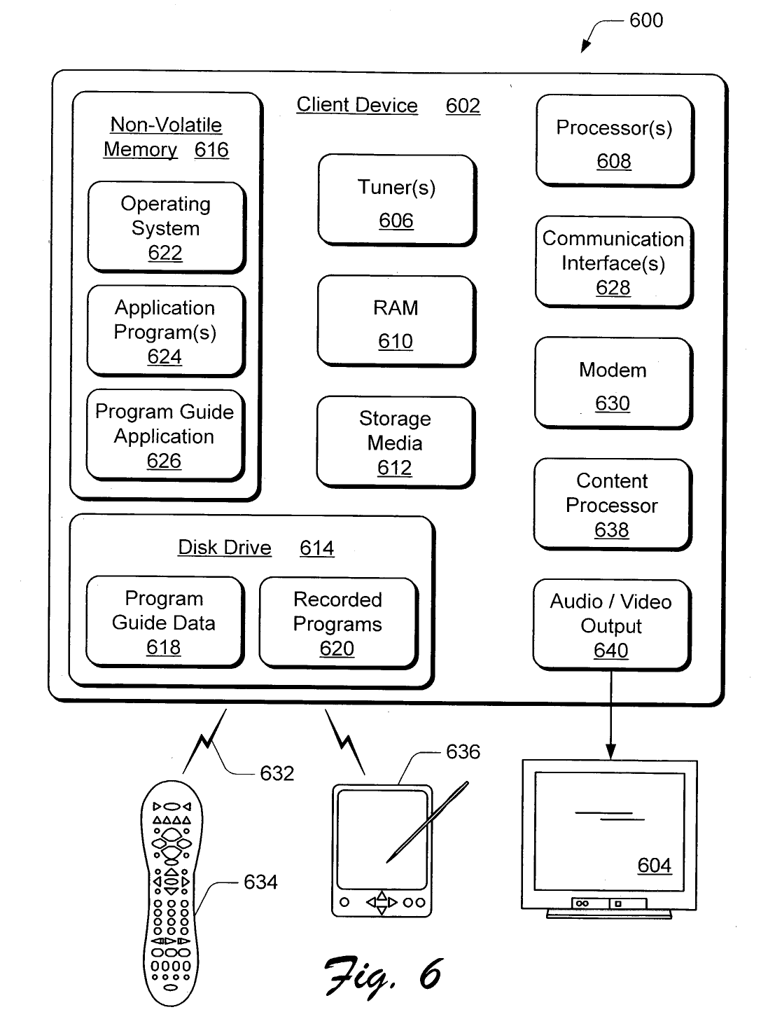

In this example, client device 102 includes a memory component 108, a program guide application 110, and one or more processors 112 (e.g., any of microprocessors, controllers, and the like) which process various instructions to control the operation of client device 102 and to communicate with other electronic and computing devices. Although not shown in this example, client device 102 may be implemented with any number and combination of differing components as further described below with reference to FIG. 6.

Client device 102 maintains, or otherwise stores, pending tasks 114 with memory component 108 when a task is paused, for example, such that a user can recall the task and resume an associated operation or function of the task. The pending tasks 114 that are maintained with memory component 108 can be recalled based on a first-in, first-out order, or based on a first-in, last-out order. Memory component 108 can be implemented as a stack with a disk drive, such as in a digital video recorder or personal video recorder, for example.

Program guide application 110 executes on processor(s) 112 and can be stored as computer-executable instructions in a non-volatile memory (e.g., memory component 108) of client device 102. Program guide application 110 is implemented to control the operational state of new, active, and pending tasks 114, as well as generate on-screen indications and viewer messages in an on-screen information bar 116 displayed on display device 104. The program guide application 110 generates and provides a user interface by which a viewer can interface with the new, active, and pending tasks via an input control device 118, such as a hand-held remote control, for example. Although program guide application 110 is illustrated and described as a single application configured for task management to implement the viewing selection management system 100, program guide application 110 can be implemented as several component applications distributed to each perform one or more functions in a digital video recorder system, a personal video recorder system, and/or any other client device in a television-based entertainment and information system.

The input control device 118 can include dedicated or programmed selectable controls (e.g., selection buttons or switches) that, when selected, initiate a task control. For example, the selectable controls include a play button to accept a new task or start a pending task, a stop button to deny a new task or delete a pending task, and a pause button to pause an active task or an activated pending task. The selectable controls can also include a task loop, or review, control to browse through a channel display of pending tasks, a picture-in-picture button to turn on/off a picture-in-picture display, and a switch button (e.g., last, jump, previous, etc.) to switch the presentation of two or more displays on a display device. For the viewing selection management system described herein, the play, stop, pause, switch, and picture-in-picture selectable controls are implemented to control the multiple tasks because viewers are already familiar with these controls and their function, and because these controls provide intuitive and common task control for an interactive television system.

Client device 102 also includes multiple task content processor(s), such as a first task content processor 120 and a second task content processor 122. The task content processors 120 and 122 are implemented to generate task displays, such as a primary task display 124 and a secondary, picture-in-picture, task display 126, respectively. In this example, the primary task display 124 can be a first viewing selection, such as a television program or a movie, and the second task display 126 can be a second viewing selection, such as a picture-in-picture display of an incoming video-phone call.

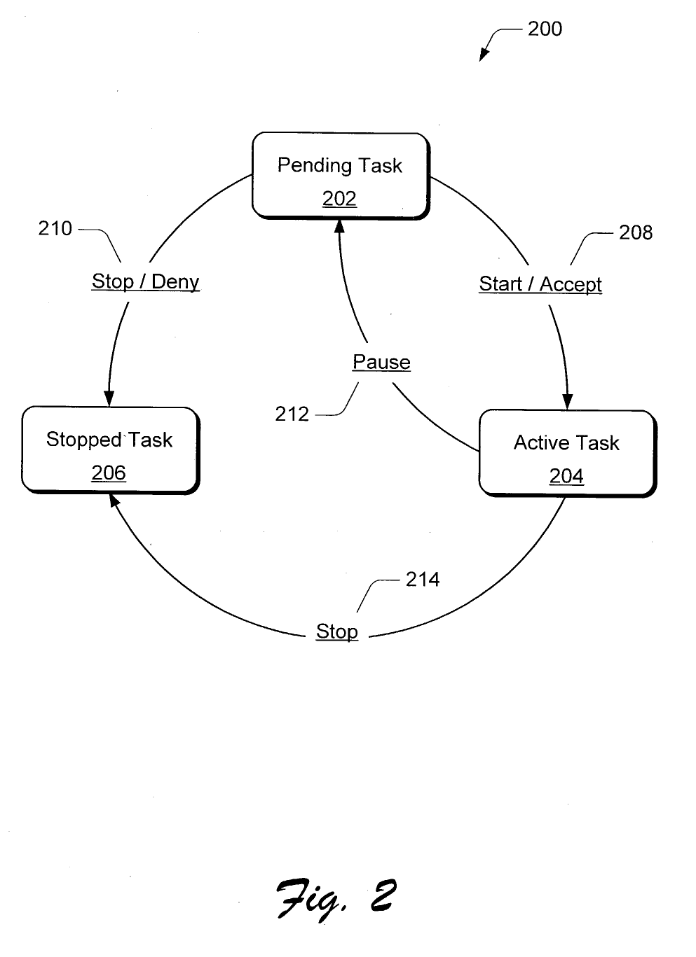

FIG. 2 illustrates an example of a state diagram 200 for the viewing selection management system 100 shown in FIG. 1. The diagram 200 includes one of three task states to describe and control each new, active, or pending task. A task can be identified as a pending task 202, an active task 204, or a stopped task 206. A pending task 202, for example, corresponds to a pending task 114 (FIG. 1) maintained with memory component 108 in client device 102. Further, a pending task 202 can include a new task that is received by client device 104, such as an incoming video-phone call. A pending task 202 can be started from the stack (e.g., memory component 108) or a new task can be accepted 208 to become an active task 204. Examples of an active task 204 include the primary display 122 and the picture-in-picture display 124 shown in FIG. 1.

A pending task 202 can also be stopped or a new task can be denied 210 in which case a pending task 114 is deleted from the stack (e.g., memory component 108) or an incoming new task is not accepted and deleted. An active task 204 can be paused 212 to create a pending task 202 that is stored on the stack. Additionally, an active task 204 can also be stopped 214 to delete the task.

Methods for a viewing selection management system may be described in the general context of computer-executable instructions. Generally, computer-executable instructions include routines, programs, objects, components, data structures, and the like that perform particular functions or implement particular abstract data types. The described methods may also be practiced in distributed computing environments where functions are performed by remote processing devices that are linked through a communications network. In a distributed computing environment, computer-executable instructions may be located in both local and remote computer storage media, including memory storage devices.

The order in which a method is described is not intended to be construed as a limitation, and any number of the described method blocks in a particular method can be combined in any order to implement the method. Furthermore, the methods can be implemented in any suitable hardware, software, firmware, or combination thereof.

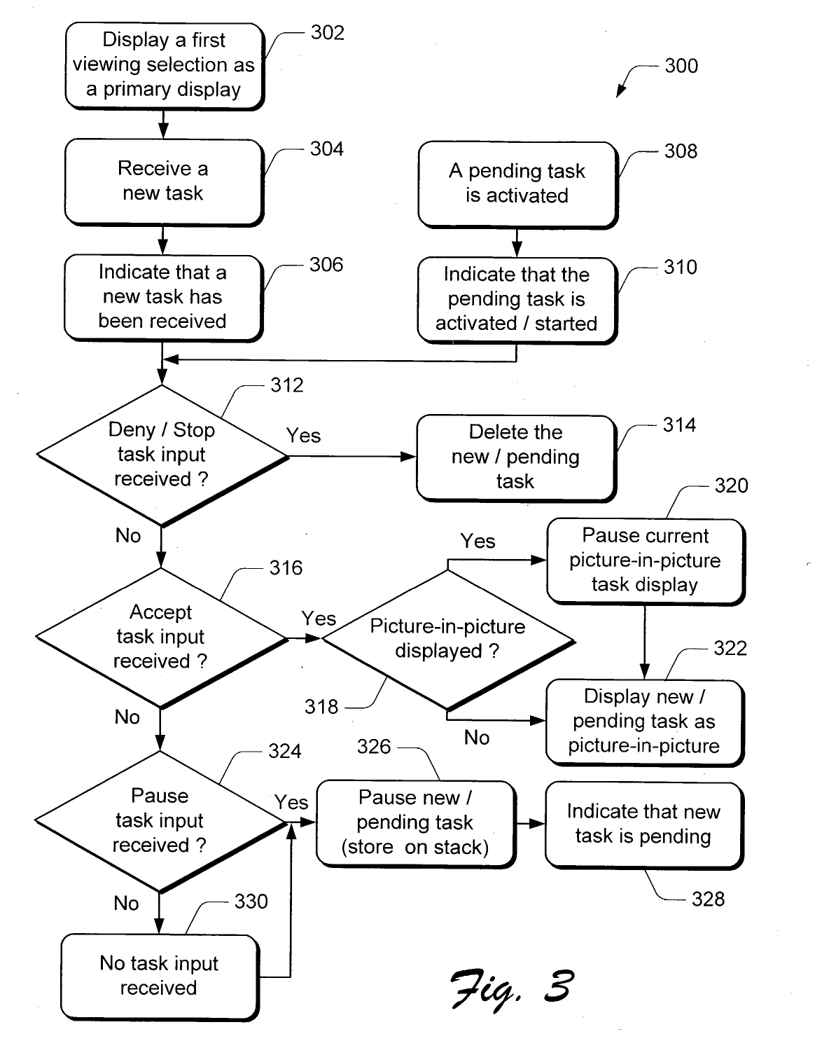

FIG. 3 illustrates a method 300 for a viewing selection management system, such as the exemplary system 100 shown in FIG. 1. At block 302, a first viewing selection is displayed as a primary display. For example, the first task content processor 120 (FIG. 1) generates the primary display 124. At block 304, a new task is received. For example, processor 112 receives a new task, such as an incoming video-phone call, via the transmission media 106. At block 306, an indication that the new task has been received is displayed. For example, the on-screen information bar 116 is displayed on display device 104 to indicate that a new task has been received, such as the incoming video-phone call.

At block 308, a pending task is activated. For example, processor 112 receives an input from a remote user to activate, or reactivate, a pending task, such as a video-phone call that has been paused by a user of client device 102. At block 310, an indication is displayed that a pending task has been activated and/or started. For example, the on-screen information bar 116 is displayed on display device 104 to indicate that a pending task has been activated.

At block 312, a determination is made as to whether a deny or stop task input has been received. For example, a user selectable task input can be received via remote control 118 to stop a pending task or to deny an incoming task. If a deny or stop task input is received (i.e., “yes” from block 312), then the new or pending task is deleted at block 314. For example, a pending task 114 that has been remotely activated can be deleted from the stack (e.g., memory component 108). If a deny or stop task input is not received (i.e., “no” from block 312), a determination is made as to whether an accept task input is received at block 316.

If an accept task input is received (i.e., “yes” from block 316), then a determination is made as to whether a task is currently being displayed as a picture-in-picture within the primary display at block 318. If a task is currently being displayed as a picture-in-picture (i.e., “yes” from block 318), then the current task displayed as the picture-in-picture display is paused at block 320 (e.g., the current task is stored on the stack as an additional pending task) and the new or pending task is displayed as the picture-in-picture within the primary display at block 322. If a task is not currently being displayed as a picture-in-picture (i.e., “no” from block 318), then the new or pending task is displayed as the picture-in-picture within the primary display at block 322.

If an accept task input is not received (i.e., “no” from block 316), then a determination is made as to whether a pause task input is received at block 324. If a pause task input is received (i.e., “yes” from block 324), then the new or pending task is paused at block 326. For example, a pending task 114 continues to be paused, or a new incoming task is stored on the stack to create an additional pending task. Additionally, an indication that the new task is pending is displayed at block 328. If a pause task input is not received (i.e., “no” from block 324), then the determination is that no input will be received at block 330 (e.g., after a time duration). If no input is received, then the new or pending task is paused at block 326 and an indication that the new task is pending is displayed at block 328.

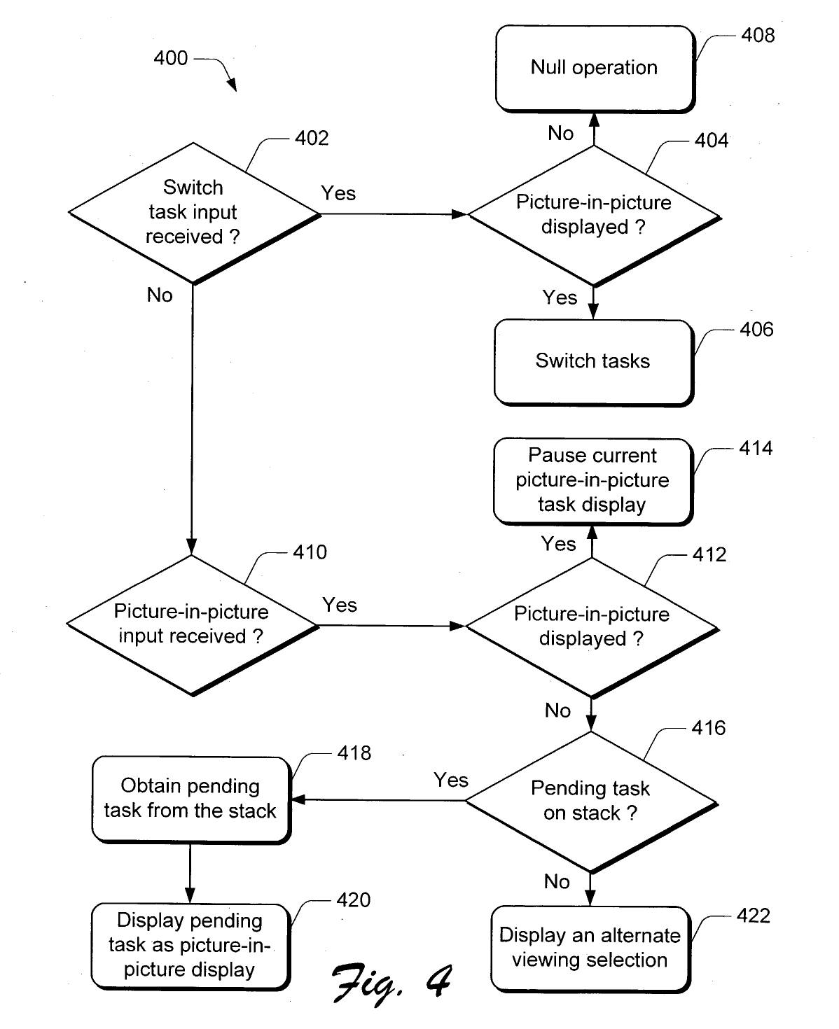

FIG. 4 illustrates a method 400 for a viewing selection management system, such as the exemplary system 100 shown in FIG. 1. At block 402, a determination is made as to whether a switch task input is received. If a switch task input is received (i.e., “yes” from block 402), a determination is made as to whether a task is currently being displayed as a picture-in-picture within the primary display at block 404. If a task is currently being displayed as a picture-in-picture (i.e., “yes” from block 404), then the tasks are switched at block 406. For example, the second viewing selection that is currently displayed as a picture-in-picture 126 within the primary display 124 is displayed as the primary display, and the first viewing selection that is displayed as the primary display 124 is displayed as the picture-in-picture within the primary display. If a task is not currently being displayed as a picture-in-picture (i.e., “no” from block 404), the switch input task is a null operation at block 408.

If a switch task input is not received (i.e., “no” from block 402), then a determination is made as to whether a picture-in-picture input is received at block 1410. If a picture-in-picture input is received (i.e., “yes” from block 410), a determination is made as to whether a task is currently being displayed as a picture-in-picture within the primary display at block 412. If a task is currently being displayed as a picture-in-picture (i.e., “yes” from block 412), then the task currently being displayed as the picture-in-picture is paused at block 414 (e.g., the current task is stored on the stack as an additional pending task).

If a task is not currently being displayed as a picture-in-picture (i.e., “no” from block 412), a determination is made as to whether a task is pending on the stack at block 416. If a task is pending on the stack (i.e., “yes” from block 416), then a pending task is obtained from the stack at block 418 and the pending task is displayed as the picture-in-picture within the primary display at block 420. If a task is not pending on the stack (i.e., “no” from block 416), then an alternate viewing selection is displayed as the primary display at block 422. For example, program guide application 110 can obtain one of a user's favorite programming channels and initiate that a task content processor generate a display of an associated program.

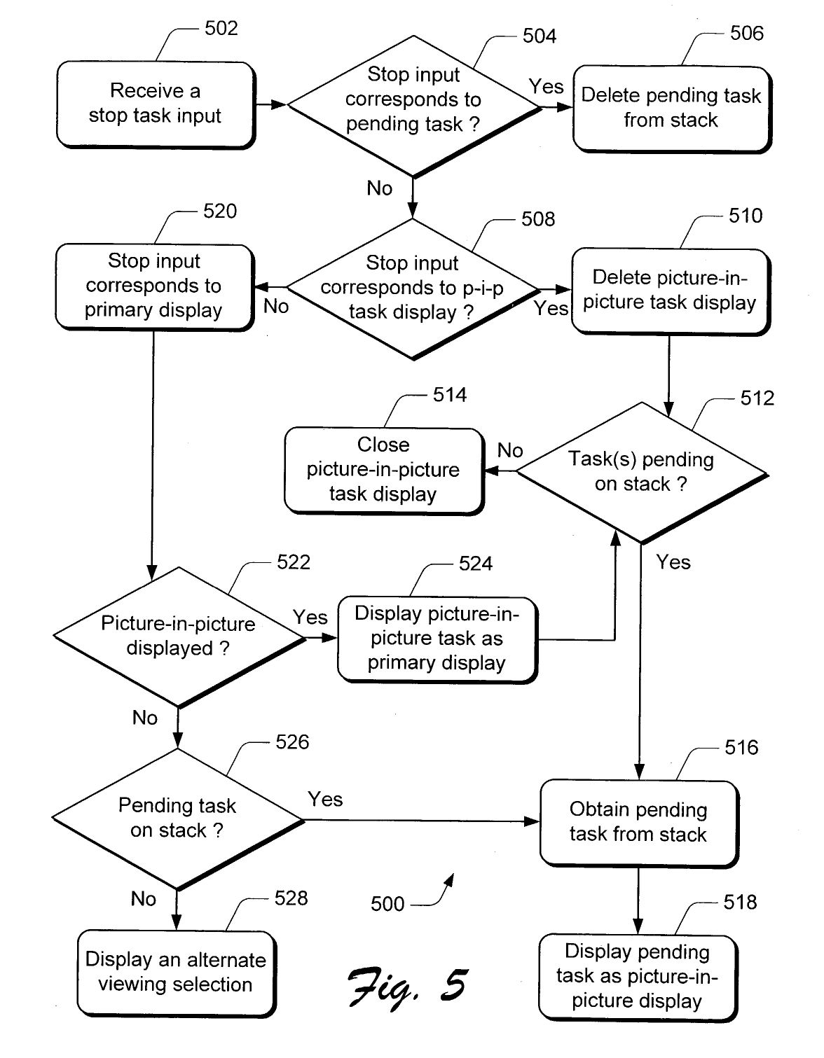

FIG. 5 illustrates a method 500 for a viewing selection management system, such as the exemplary system 100 shown in FIG. 1. At block 502, a stop task input is received. For example, a processor 112 in client device 102 (FIG. 1) receives a user selectable task input via remote control 118 to stop a task currently being displayed as a picture-in-picture display 126, a task being displayed as a viewing selection in the primary display 124, or a pending task 114 (e.g., delete the pending task from memory component 108).

At block 504, a determination is made as to whether the stop task input corresponds to a pending task stored on the stack. The determination can be based on a selection focus, or hi-lite, that designates the pending task within a display. If the stop task input does correspond to a pending task stored on the stack (i.e., “yes” from block 504), then the pending task is deleted from the stack at block 506. If the stop task input does not correspond to a pending task (i.e., “no” from block 504), then a determination is made as to whether the stop input corresponds to a task currently being displayed as a picture-in-picture within the primary display at block 508.

If the stop task input does correspond to a picture-in-picture task display (e.g., a second viewing selection within the primary display) (i.e., “yes” from block 508), then the task being displayed as the picture-in-picture is deleted at block 510. Additionally, a determination is made as to whether there are one or more tasks pending on the stack at block 512. If there is not a pending task on the stack (i.e., “no” from block 512), then the picture-in-picture task display is closed at block 514. If there is one or more pending tasks (i.e., “yes” from block 512), then a pending task is obtained from the stack at block 516 and the pending task is displayed as the picture-in-picture within the primary display at block 518.

If the stop task input does not correspond to a picture-in-picture task display (i.e., “no” from block 508), then the determination is that the stop input corresponds to the primary display at block 520. At block 522, a determination is made as to whether a task is currently being displayed as a picture-in-picture within the primary display. If a task is currently being displayed as a picture-in-picture (i.e., “yes” from block 522), then the current task being displayed as the picture-in-picture is displayed as the primary display at block 524. Additionally, a determination is made as to whether there are one or more tasks pending on the stack at block 512. If there is not a pending task on the stack (i.e., “no” from block 512), then the picture-in-picture task display is closed at block 514. If there are one or more pending tasks (i.e., “yes” from block 512), then a pending task is obtained from the stack at block 516 and the pending task is displayed as the picture-in-picture within the primary display at block 518.

If a task is not currently being displayed as a picture-in-picture (i.e., “no” from block 522), a determination is made as to whether a task is pending on the stack at block 526. If a task is pending on the stack (i.e., “yes” from block 526), then a pending task is obtained from the stack at block 516 and the pending task is displayed as the picture-in-picture within the primary display at block 518. If a task is not pending on the stack (i.e., “no” from block 526), an alternate viewing selection is displayed as the primary display at block 528.

FIG. 6 illustrates a television-based system 600 that includes an exemplary client device 602 which includes components to implement a viewing selection management system, such as the exemplary system 100 (FIG. 1). System 600 also includes a display device 604 to display a first task viewing selection (e.g., first viewing selection 124) and display a picture-in-picture (e.g., second viewing selection 126) within the first viewing selection. Client device 602 can be implemented as a set-top box, a satellite receiver, a TV recorder with a hard disk, a digital video recorder (DVR) and playback system, a personal video recorder (PVR) and playback system, a game console, an appliance device configured to implement a viewing selection management system, and as any number of similar embodiments.

Client device 602 includes one or more tuners 606 which are representative of one or more in-band tuners that tune to various frequencies or channels to receive television signals, as well as an out-of-band tuner that tunes to the broadcast channel over which program and/or task data is broadcast to client device 602. Client device 602 also includes one or more processors 608 (e.g., any of microprocessors, controllers, and the like) which process various instructions to control the operation of client device 602 and to communicate with other electronic and computing devices.

Client device 602 can be implemented with one or more memory components, examples of which include a random access memory (RAM) 610, mass storage media 612, a disk drive 614, and a non-volatile memory 616 (e.g., ROM, Flash, EPROM, EEPROM, etc.). Disk drive 614 can include any type of magnetic or optical storage device, such as a hard disk drive, a magnetic tape, a rewriteable compact disc, a DVD, and the like. The one or more memory components store various information and/or data such as received content, program guide data 618, recorded programs 620, configuration information for client device 602, and/or graphical user interface information. Alternative implementations of client device 602 can include a range of processing and memory capabilities, and may include any number of different memory components than those illustrated in FIG. 6. For example, full-resource clients can be implemented with substantial memory and processing resources, whereas low-resource clients may have limited processing and memory capabilities.

An operating system 622 and one or more application programs 624 can be stored in non-volatile memory 616 and executed on processor(s) 608 to provide a runtime environment. A runtime environment facilitates extensibility of client device 602 by allowing various interfaces to be defined that, in turn, allow application programs 624 to interact with client device 602. The application programs 624 can include a browser to browse the Web (e.g., “World Wide Web”), an email program to facilitate electronic mail, and any number of other application programs.

A program guide application 626 that executes on processor(s) 608 is also stored in non-volatile memory 616 and is implemented to process the program guide data 618 and manage the tasks for the viewing selection management system 100 (FIG. 1). Program guide application 626 generates the program guides which enable a viewer to navigate through an onscreen display and locate broadcast programs, recorded programs, video on-demand programs and movies, interactive game selections, pending tasks, and other media access information or content of interest to the viewer. With program guide application 626, the television viewer can look at schedules of current and future programming, set reminders for upcoming programs, and/or enter instructions to record one or more programs.

Client device 602 further includes one or more communication interfaces 628 and a PSTN, DSL, cable, or other type of modem 630. A communication interface 628 can be implemented as a serial and/or parallel interface, as a wireless interface, and/or as any other type of network interface. A wireless interface enables client device 602 to receive control input commands 632 and other information from a user-operated input device, such as from a remote control device 634 or from another infrared (IR), 802.11, Bluetooth, or similar RF input device. Input devices can include a wireless keyboard or another handheld input device 636 such as a personal digital assistant (PDA), handheld computer, wireless phone, or the like. A network interface and a serial and/or parallel interface enables client device 602 to interact and communicate with other electronic and computing devices via various communication links. Modem 630 facilitates client device 602 communication with other electronic and computing devices via a conventional telephone line, a DSL connection, cable, and/or other type of connection.

Client device 602 also includes a content processor 638 which can include a video decoder and/or additional processors to receive, process, and decode broadcast video signals and program data, such as NTSC, PAL, SECAM, or other television system analog video signals, as well as DVB, ATSC, or other television system digital video signals. The content processor 638 can also receive, process, and decode content and/or media streamed over the Internet or a broadband network. For example, content processor 638 can include an MPEG-2 or MPEG-4 (Moving Pictures Experts Group) decoder that decodes MPEG-encoded video content and/or image data. Content processor 638 may also include a decoder for any other type of media format. The systems described herein can be implemented for any type of video encoding format as well as for data and/or content streams that are not encoded.

Typically, video content and program data includes video data and corresponding audio data. Content processor 638 generates video and/or display content that is formatted for display on display device 604, and generates decoded audio data that is formatted for presentation by a presentation device, such as one or more speakers (not shown) in display device 604. Content processor 638 can include a display controller (not shown) that processes the video and/or display content to display corresponding images on display device 604. A display controller can include a graphics processor, microcontroller, integrated circuit, and/or similar video processing component to process the images.

Client device 602 also includes an audio and/or video output 640 that provides the audio, video, and/or display signals to television 604 or to other devices that process and/or display, or otherwise render, the audio and video data. Video signals and audio signals can be communicated from client device 602 to television 604 via an RF (radio frequency) link, S-video link, composite video link, component video link, or other similar communication link.

Although shown separately, some of the components of client device 602 may be implemented in an application specific integrated circuit (ASIC). Additionally, a system bus (not shown) typically connects the various components within client device 602. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

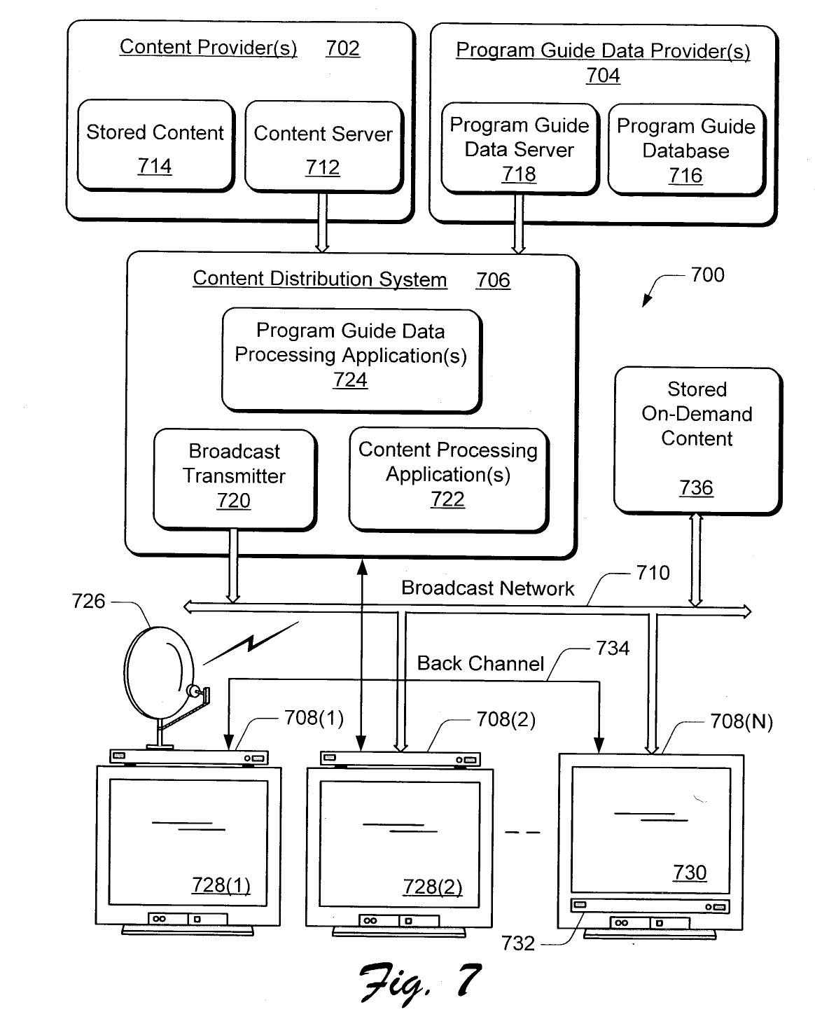

FIG. 7 illustrates an exemplary system architecture 700 in which a viewing selection management system can be implemented. System 700 facilitates distribution of content and program guide data to multiple viewers. The system 700 includes one or more content providers 702, one or more program guide data providers 704, a content distribution system 706, and multiple client devices 708(1), 708(2), . . . , 708(N) coupled to the content distribution system 706 via a broadcast network 710.

A content provider 702 can be implemented as a satellite operator, a network television operator, a cable operator, and the like. A content provider 702 includes a content server 712 to control distribution of stored content 714, such as movies, television programs, commercials, music, and similar audio, video, and/or image content from content provider 702 to the content distribution system 706. Additionally, content server 712 controls distribution of live content (e.g., content that was not previously stored, such as live feeds) and/or content stored at other locations to the content distribution system 706.

A program guide data provider 704 includes a program guide database 716 and a program guide data server 718. The program guide database 716 stores electronic files of program guide data which is used to generate an electronic or interactive program guide (or, “program guide”). Program guide data can include a program title, program broadcast day(s) to identify which days of the week the program will be broadcast, program start times(s) to identify a time that the program will be broadcast on the particular day or days of the week, and a program category. A program category describes the genre of a program and categorizes it as a particular program type. For example, a program can be categorized as a movie, a comedy, a sporting event, a news program, a sitcom, a talk show, or as any number of other category descriptions. Program guide data can also include program ratings, characters, descriptions, actor names, station identifiers, channel identifiers, other schedule information, and so on. Additionally, program guide data may include video on-demand content information, such as movie schedules, as well as application information, such as for interactive games, and other programming information that may be of interest to a viewer.

The program guide data server 718 processes the program guide data prior to distribution to generate a published version of the program guide data which can contain programming information for all broadcast channels and on-demand content listings for one or more days. The processing may involve any number of techniques to reduce, modify, or enhance the program data such as data compression, format modification, and the like. The program guide data server 718 controls distribution of the published version of the program guide data from a program guide data provider 704 to the content distribution system 706 using, for example, a file transfer protocol (FTP) over a TCP/IP network (e.g., Internet or Intranet). Further, the published version of the program guide data can be transmitted from program data provider 704 via a satellite and the content distribution system 706 directly to a client device 708.

Content distribution system 706 is representative of a headend service and/or program data center that provides program guide data, as well as content, to multiple subscribers (e.g., client devices 708). Each content distribution system 706 may receive a different version of the program guide data that takes into account different programming preferences and lineups. The program guide data server 718 can create different versions of the program guide data that includes those channels of relevance to respective headend services, and the content distribution system 706 transmits the program guide data to the multiple client devices 708. In one implementation, for example, content distribution system 706 utilizes a carousel file system to repeatedly broadcast the program guide data over an out-of-band channel to the client devices 708. Alternatively, the multiple client devices 708 can receive standard, or uniform, program guide data and individually determine which program guide data to display based on the associated headend service.

Content distribution system 706 includes a broadcast transmitter 720, one or more content processing applications 722, and one or more program guide data processing applications 724. Broadcast transmitter 720 broadcasts signals, such as cable television signals, across broadcast network 710. Broadcast network 710 can include a cable television network, RF, microwave, satellite, and/or data network, such as the Internet, and may also include wired or wireless transmission media using any broadcast format or broadcast protocol. Additionally, broadcast network 710 can be any type of network, using any type of network topology and any network communication protocol, and can be represented or otherwise implemented as a combination of two or more networks.

A content processing application 722 processes the content received from a content provider 702 prior to transmitting the content across broadcast network 710. Similarly, a program guide data processing application 724 processes the program guide data received from a program guide data provider 704 prior to transmitting the program guide data across broadcast network 710. A particular content processing application 722 may encode, or otherwise process, the received content into a format that is understood by the multiple client devices 708 which are coupled to broadcast network 710. Although FIG. 7 shows a single content provider 702, a single program guide data provider 704, and a single content distribution system 706, exemplary system 700 can include any number of content providers and/or program guide data providers coupled to any number of content distribution systems.

Client devices 708 can be implemented in a number of ways. For example, a client device 708(1) receives broadcast content from a satellite-based transmitter via a satellite dish 726. Client device 708(1) is also referred to as a set-top box or a satellite receiving device. Client device 708(1) is coupled to a television 728(1) for presenting the content received by the client device (e.g., audio data, video data, and image data), as well as a graphical user interface. A particular client device 708 can be coupled to any number of televisions 728 and/or similar devices that can be implemented to display or otherwise render content. Similarly, any number of client devices 708 can be coupled to a single television 728.

Client device 708(2) is also coupled to receive broadcast content from broadcast network 710 and provide the received content to associated television 728(2). Client device 708(N) is an example of a combination television 730 and integrated set-top box 732. In this example, the various components and functionality of the set-top box are integrated into the television, rather than using two separate devices. The set-top box integrated into the television can receive broadcast signals via a satellite dish (similar to satellite dish 726) and/or via broadcast network 710. In alternate implementations, client devices 708 may receive broadcast signals via the Internet or any other broadcast medium, such as back channel 734 which can be implemented as a Internet protocol (IP) connection or as other protocol connections using a modem connection and conventional telephone line, for example. Further, back channel 734 provides an alternate communication link between each of the client devices 708, and between the client devices 708 and the content distribution system 706.

The exemplary system 700 also includes stored on-demand content 736, such as video on-demand (VOD) movie content. The stored on-demand content 736 can be viewed with a television 728 via a client device 708 through an onscreen movie guide, for example, and a viewer can enter instructions to stream a particular movie, or other stored content, to a corresponding client device 708.

Although the invention has been described in language specific to structural features and/or methods, it is to be understood that the invention defined in the appended claims is not necessarily limited to the specific features or methods described. Rather, the specific features and methods are disclosed as preferred forms of implementing the claimed invention.

1. A method, comprising:
displaying a first viewing selection as a primary display;
receiving a task input corresponding to a task, the task input being at least one of an accept task input, a pause task input, a deny task input, and no input;
displaying the task as a second viewing selection within the primary display in an event that the accept task input is received;
deleting the task in an event that the deny task input is received; and
storing the task on a stack in an event that at least one of the pause task input and no input is received.

2. A method as recited in claim 1, wherein displaying the task includes displaying the task as a picture-in-picture within the primary display.

3. A method as recited in claim 1, further comprising indicating that the task has been received.

4. A method as recited in claim 1, further comprising indicating that the task is pending when storing the task on the stack.

5. A method as recited in claim 1, further comprising:
receiving a second accept task input corresponding to a second task, the second accept task input received when the second viewing selection is displaying within the primary display;
storing the task being displayed as the second viewing selection on the stack; and
displaying the second task as the second viewing selection within the primary display.

6. A method as recited in claim 1, further comprising:
indicating that a pending task has been activated;
receiving a second accept task input corresponding to the pending task, the second accept task input received when the second viewing selection is displaying within the primary display;
storing the task being displayed as the second viewing selection on the stack; and
displaying the pending task as the second viewing selection within the primary display.

7. A method as recited in claim 1, further comprising:
indicating that a pending task has been activated; and
receiving a second pause task input to continue pausing the pending task.

8. A method as recited in claim 1, further comprising:
indicating that a pending task has been activated; and
receiving a stop task input to delete the pending task.

9. A method as recited in claim 1, further comprising:
receiving a start task input to activate a pending task, the start task input received when the second viewing selection is displaying within the primary display;
storing the task being displayed as the second viewing selection on the stack; and
displaying the pending task as the second viewing selection within the primary display.

10. A method as recited in claim 1, further comprising:
receiving a switch task input when the task is displaying as the second viewing selection within the primary display;
displaying the task as the primary display; and
displaying the first viewing selection within the primary display.

11. A method as recited in claim 1, further comprising:
receiving a picture-in-picture input when the task is displaying as the second viewing selection within the primary display; and
storing the task on the stack to pause the task.

12. A method as recited in claim 1, further comprising:
receiving a picture-in-picture input when there is no second viewing selection displayed within the primary display;
obtaining a pending task from the stack; and
displaying the pending task as the second viewing selection within the primary display.

13. A method as recited in claim 1, further comprising:
receiving a stop task input corresponding to a pending task being stored on the stack; and
deleting the pending task.

14. A method as recited in claim 1, further comprising:
receiving a stop task input corresponding to the task being displayed as the second viewing selection within the primary display;
deleting the task being displayed as the second viewing selection;
obtaining a pending task from the stack; and
displaying the pending task as the second viewing selection within the primary display.

15. A method as recited in claim 1, further comprising:
receiving a stop task input corresponding to the task being displayed as the second viewing selection within the primary display;
deleting the task being displayed as the second viewing selection; and
closing a picture-in-picture display of the second viewing selection if there are no pending tasks on the stack.

16. A method as recited in claim 1, further comprising:
receiving a stop task input corresponding to the first viewing selection;
if the task is displaying as the second viewing selection within the primary display:
displaying the task as the primary display;
obtaining a pending task from the stack if one or more tasks are pending; and
displaying the pending task as the second viewing selection within the primary display.

17. A method as recited in claim 1, further comprising:
receiving a stop task input corresponding to the first viewing selection;
if the task is displaying as the second viewing selection within the primary display:
displaying the task as the primary display; and
closing a picture-in-picture display of the second viewing selection if there are no pending tasks on the stack.

18. A method as recited in claim 1, further comprising:
receiving a stop task input corresponding to the first viewing selection;
if there is no second viewing selection displayed within the primary display:
obtaining a pending task from the stack if one or more tasks are pending; and
displaying the pending task as the primary display.

19. A method as recited in claim 1, further comprising:
receiving a stop task input corresponding to the first viewing selection; and
if there is no second viewing selection displayed within the primary display:
displaying an alternate viewing selection as the primary display if there are no pending tasks on the stack.

20. One or more computer-readable media comprising computer-executable instructions that, when executed, direct a client device in a television-based system to perform the method of claim 1.

21. One or more computer-readable media comprising computer-executable instructions that, when executed, direct an appliance device to perform the method of claim 1.

22. One or more computer-readable media comprising computer-executable instructions that, when executed, direct an electronic program guide to perform the method of claim 1.

23. A client device in a television-based system, comprising:
a processor configured to receive a task input corresponding to a task, the task input being at least one of an accept task input, a pause task input, a deny task input, and no input;
a first task content processor configured to render a first viewing selection as a primary display;
a second task content processor configured to render the task as a second viewing selection within the primary display in an event that the accept task input is received;
an application program configured to initiate that the task be deleted in an event that the deny task input is received; and
memory component configured to store the task in an event that at least one of the pause task input and no input is received.

24. A client device in a television-based system as recited in claim 23, wherein the second task content processor is further configured to render the task as a picture-in-picture within the primary display.

25. A client device in a television-based system as recited in claim 23, wherein the application program is further configured to initiate an indication that the task has been received.

26. A client device in a television-based system as recited in claim 23, wherein the application program is further configured to initiate an indication that the task is pending when the task is stored on the stack.

27. A client device in a television-based system as recited in claim 23, wherein:
the processor is further configured to receive a second accept task input corresponding to a second task, the second accept task input being received when the second viewing selection is rendered within the primary display;
the memory component is further configured to store the task being rendered as the second viewing selection in response to the second accept task input; and
the second task content processor is further configured to render the second task as the second viewing selection within the primary display.

28. A client device in a television-based system as recited in claim 23, wherein:
the application program is further configured to initiate an indication that a pending task has been activated;
the processor is further configured to receive a second accept task input, the second accept task input being received when the second viewing selection is rendered within the primary display;
the memory component is further configured to store the task being rendered as the second viewing selection in response to the second accept task input; and
the second task content processor is further configured to render the pending task as the second viewing selection within the primary display.

29. A client device in a television-based system as recited in claim 23, wherein:
the application program is further configured to initiate an indication that a pending task has been activated; and
the processor is further configured to receive a second pause task input to continue pausing the pending task.

30. A client device in a television-based system as recited in claim 23, wherein:
the application program is further configured to initiate an indication that a pending task has been activated; and
the processor is further configured to receive a stop task input to delete the pending task from the memory component.

31. A client device in a television-based system as recited in claim 23, wherein:
the processor is further configured to receive a start task input to activate a pending task when the second viewing selection is rendered within the primary display;
the memory component is further configured to store the task being rendered as the second viewing selection in response to the start task input; and
the second task content processor is further configured to render the pending task as the second viewing selection within the primary display.

32. A client device in a television-based system as recited in claim 23, wherein:
the processor is further configured to receive a switch task input when the task is being rendered as the second viewing selection within the primary display;
the first task content processor is further configured to render the task as the primary display; and
the second task content processor is further configured to render the first viewing selection within the primary display as a picture-in-picture.

33. A client device in a television-based system as recited in claim 23, wherein:
the processor is further configured to receive a picture-in-picture input when the task is being rendered as the second viewing selection within the primary display; and
the memory component is further configured to store the task to pause the task.

34. A client device in a television-based system as recited in claim 23, wherein:
the processor is further configured to receive a picture-in-picture input when there is no second viewing selection being rendered within the primary display;
the application program is further configured to initiate that a pending task be obtained from the memory component; and
the second task content processor is further configured to render the pending task as the second viewing selection within the primary display.

35. A client device in a television-based system as recited in claim 23, wherein:
the processor is further configured to receive a stop task input corresponding to a pending task being maintained by the memory component; and
the application program further configured to initiate that the pending task be deleted.

36. A client device in a television-based system as recited in claim 23, wherein:
the processor is further configured to receive a stop task input corresponding to the task being rendered as the second viewing selection within the primary display;
the application program is further configured to initiate that the task be deleted, and initiate that a pending task be obtained from the memory component; and
the second task content processor is further configured to render the pending task as the second viewing selection within the primary display.

37. A client device in a television-based system as recited in claim 23, wherein:
the processor is further configured to receive a stop task input corresponding to the task being rendered as the second viewing selection within the primary display; and
the application program is further configured to initiate that the task be deleted, and initiate that a picture-in-picture display of the second viewing selection be closed if there are no pending tasks on the stack.

38. A client device in a television-based system as recited in claim 23, wherein:
the processor is further configured to receive a stop task input corresponding to the first viewing selection;
if the task is being rendered as the second viewing selection within the primary display:
the first task content processor is further configured to render the task as the primary display;
the application program is further configured to initiate that a pending task be obtained from the memory component if one or more tasks are pending; and
the second task content processor is further configured to render the pending task as the second viewing selection within the primary display.

39. A client device in a television-based system as recited in claim 23, wherein:
the processor is further configured to receive a stop task input corresponding to the first viewing selection;
if the task is being rendered as the second viewing selection within the primary display:
the first task content processor is further configured to render the task as the primary display; and
the application program is further configured to initiate that a picture-in-picture display of the second viewing selection be closed if there are no pending tasks.

40. A client device in a television-based system as recited in claim 23, wherein:
the processor is further configured to receive a stop task input corresponding to the first viewing selection;
if there is no second viewing selection being rendered within the primary display:
the application program is further configured to initiate that a pending task be obtained from the memory component if one or more tasks are pending; and
the first task content processor is further configured to render the pending task as the primary display.

41. A client device in a television-based system as recited in claim 23, wherein:
the processor is further configured to receive a stop task input corresponding to the first viewing selection; and
if there is no second viewing selection being rendered within the primary display, the first task content processor is further configured to render an alternate viewing selection as the primary display if there are no pending tasks.

42. A digital video recorder comprising the client device as recited in claim 23.

43. One or more computer-readable media comprising computer-executable instructions that, when executed, direct a viewing selection management system to:
determine that a task input corresponding to a task is at least one of an accept task input, a pause task input, a deny task input, and no input;
render the task as a picture-in-picture within a first viewing selection in an event that the accept task input is received;
delete the task in an event that the deny task input is received; and
maintain the task on a stack in an event that at least one of the pause task input and no input is received.

44. One or more computer-readable media as recited in claim 43, further comprising computer executable instructions that, when executed, direct the viewing selection management system to indicate that the task has been received.

45. One or more computer-readable media as recited in claim 43, further comprising computer executable instructions that, when executed, direct the viewing selection management system to indicate that the task is pending when the task is maintained on the stack.

46. One or more computer-readable media as recited in claim 43, further comprising computer executable instructions that, when executed, direct the viewing selection management system to:
maintain the task on the stack in response to a second accept task input that corresponds to a second task, the second accept task input being received when the task is being rendered as the picture-in-picture within the first viewing selection; and
render the second task as the picture-in-picture within the first viewing selection.

47. One or more computer-readable media as recited in claim 43, further comprising computer executable instructions that, when executed, direct the viewing selection management system to:
indicate that a pending task has been activated when the task is being rendered as the picture-in-picture within the first viewing selection;
maintain the task on the stack in response to a second accept task input; and
render the pending task as the picture-in-picture within the first viewing selection.

48. One or more computer-readable media as recited in claim 43, further comprising computer executable instructions that, when executed, direct the viewing selection management system to:
indicate that a pending task has been activated; and
continue pausing the pending task when a second pause task input is received.

49. One or more computer-readable media as recited in claim 43, further comprising computer executable instructions that, when executed, direct the viewing selection management system to:
indicate that a pending task has been activated; and
delete the pending task when a stop task input is received.

50. One or more computer-readable media as recited in claim 43, further comprising computer executable instructions that, when executed, direct the viewing selection management system to:
maintain the task on the stack when a start task input is received to activate a pending task, the start task input being received when the task is being rendered as the picture-in-picture within the first viewing selection; and
render the pending task as the picture-in-picture within the first viewing selection.

51. One or more computer-readable media as recited in claim 43, further comprising computer executable instructions that, when executed, direct the viewing selection management system to:
render the task as a primary display when a switch task input is received and when the task is being rendered as the picture-in-picture within the first viewing selection; and
render the first viewing selection as the picture-in-picture within the primary display.

52. One or more computer-readable media as recited in claim 43, further comprising computer executable instructions that, when executed, direct the viewing selection management system to maintain the task on the stack to pause the task when a picture-in-picture input is received and when the task is being rendered as the picture-in-picture within the first viewing selection.

53. One or more computer-readable media as recited in claim 43, further comprising computer executable instructions that, when executed, direct the viewing selection management system to:
obtain a pending task from the stack when a picture-in-picture input is received and when there is no picture-in-picture being rendered within the first viewing selection; and
render the pending task as the picture-in-picture within the first viewing selection.

54. One or more computer-readable media as recited in claim 43, further comprising computer executable instructions that, when executed, direct the viewing selection management system to delete a pending task from the stack when a stop task input that corresponds to the pending task is received.

55. One or more computer-readable media as recited in claim 43, further comprising computer executable instructions that, when executed, direct the viewing selection management system to:
delete the task when a stop task input that corresponds to the task is received and when the task is being rendered as the picture-in-picture within the first viewing selection;
obtain a pending task from the stack; and
render the pending task as the picture-in-picture within the first viewing selection.

56. One or more computer-readable media as recited in claim 43, further comprising computer executable instructions that, when executed, direct the viewing selection management system to:
delete the task when a stop task input that corresponds to the task is received and when the task is being rendered as the picture-in-picture within the first viewing selection; and
close the picture-in-picture display if there are no pending tasks on the stack.

57. One or more computer-readable media as recited in claim 43, further comprising computer executable instructions that, when executed, direct the viewing selection management system to:
render the task as a primary display when a stop task input is received that corresponds to the first viewing selection and when the task is being rendered as the picture-in-picture within the first viewing selection;
obtain a pending task from the stack if one or more tasks are pending; and
render the pending task as the picture-in-picture within the primary display.

58. One or more computer-readable media as recited in claim 43, further comprising computer executable instructions that, when executed, direct the viewing selection management system to:
render the task as a primary display when a stop task input is received that corresponds to the first viewing selection and when the task is being rendered as the picture-in-picture within the first viewing selection; and
close the picture-in-picture display if there are no pending tasks on the stack.

59. One or more computer-readable media as recited in claim 43, further comprising computer executable instructions that, when executed, direct the viewing selection management system to:
obtain a pending task from the stack if one or more tasks are pending when a stop task input is received that corresponds to the first viewing selection and when there is no picture-in-picture displayed within the first viewing selection; and
render the pending task as the first viewing selection.

60. One or more computer-readable media as recited in claim 43, further comprising computer executable instructions that, when executed, direct the viewing selection management system to render an alternate viewing selection as the first viewing selection if there are no pending tasks when a stop task input that corresponds to the first viewing selection is received.
